(19) United States
(12) Patent Application Publication
(10) Pub. No.: US 2009/0169804 A1
(43) Pub. Date: Jul. 2, 2009

(54) PRESS FABRIC FOR A MACHINE FOR THE PRODUCTION OF WEB MATERIAL AND METHOD TO PRODUCE SAID PRESS FABRIC

(76) Inventors: Arved Westerkamp, Dettingen/Erms (DE); Robert Crook, Wilson, NC (US); Robert Eberhardt, Elwangen (DE)

Correspondence Address: TAYLOR & AUST, P.C., P.O. Box 560, 142. S Main Street, Avilla, IN, 46710, US

(21) Appl. No.: 12/339,564

(22) Filed: Mar. 20, 2009

Related U.S. Application Data
(60) Provisional application No. 61/015,816, filed on Dec. 21, 2007.

(51) Int. Cl. B32B 5/12; B32B 7/12; B32B 7/04

(52) U.S. Cl. 428/113; 156/327; 156/91

(57) ABSTRACT

A press fabric for a machine for the production of web material, especially paper or cardboard, including a carrying structure and at least one layer of fibrous material, which is firmly bonded with the carrying structure, at least one layer of fibrous material containing polymeric material at least partially coating fibers of this layer with a polymeric film.

### CROSS REFERENCE TO RELATED APPLICATIONS

This is a non-provisional application based upon U.S. provisional patent application Ser. No. 61/015,816, entitled “COMPOSITE PRESS FABRIC IV”, filed Dec. 21, 2007, which is incorporated herein by reference.

### BACKGROUND OF THE INVENTION

1. Field of the Invention

The present invention relates to a press fabric for a machine for the production of web material and to a method to produce said press fabric.

2. Description of the Related Art

Press fabrics of this type, which are utilized, for example, in press sections of paper machines, can be composed such that on a carrying structure, which may be a woven structure, a randomly laid structure or a so-called spiral-link structure, several layers of fibrous material are established on one web material contact side, for example, through needling. In the first instance, particle-shaped polymeric material is added into these layers of fibrous material, for example, in the form of an aqueous dispersion with polymeric particles, applied from the direction of the web material contact side. The polymeric particles move together with the liquid into the interior volume area of the fibrous material. By adapting the dimensional distribution of the particles to the pore structure of the different layers of fibrous material, which is influenced by the fibers selected for the specific layers, their dtex value, a graduation of the particle content or also the particle size can be obtained in the layers of fibrous material. Subsequently, the particles of polymeric material, which are composed of thermoplastic material, are melted, so that, due to the melting and partial embedding of the fibers, polymeric material forms in the fiber structure leaving hollow spaces, in other words, a pore structure, to absorb liquid from the web material being manufactured. One problem with the method previously described is that the described adaptation of the particle sizes to the pore structure of the various layers can, on the one hand, lead to a certain particle distribution, however, is also subject to considerable fluctuations.

What is needed in the art is a press fabric for a machine for the production of fibrous material, and a method for the manufacture of a press fabric of this type which displays a low level of compression in operation over a period of time.

### SUMMARY OF THE INVENTION

The present invention provides a press fabric, especially a press felt, for a machine for the production of web material, especially paper or cardboard, including a carrying structure and at least one layer of fibrous material which is solidly bonded with the carrying structure and which, contains polymeric material coating the fibers in this layer at least partially with a polymeric film.

In the press fabric of the present invention, fibers of at least one layer of fibrous material are coated with the polymeric film. This polymeric film causes a stiffening of the layer of fibrous material. For this reason, this layer compresses less during operation than a conventional fibrous layer. The press fabric is fluid-permeable, for example, water permeable.

The layer containing the polymeric material is located on the side of the carrying structure which faces the web material contact surface of the press fabric. Since the water absorption capacity of the press fabric is provided essentially between the web material contact surface and the carrying structure, a continuously high water absorption capacity of the press fabric is ensured.

The press fabric of the present invention may include a plurality of layers of fibrous material in which the polymeric material which coats the fibers with a film is contained. In addition, at least some of the fibers of the at least one fibrous layer may be bonded together through the polymeric film at yarn cross points and/or fiber contact points. This interlaces the fibers with each other and a highly elastic structure consisting of the fibers and the film covering the fibers is formed.

The polymeric film may be formed from an elastomer polymeric material or include same. An elastomer polymeric material may, for example, be an elastomer polyurethane.

In order to achieve a layered structure of the press fabric of the present invention, the content of polymeric material may vary in at least two layers of fibrous material. For example, it may be provided that the content of polymeric material is higher in a layer of fibrous material which is closer to the web material contact surface than in a layer of fibrous material which is located at a greater distance from the web material contact surface. Alternatively, it can be provided that the content of polymeric material is lower in a layer of fibrous material which is located closer to a web material contact surface than in a layer of fibrous material which is located at a greater distance from a web material contact surface. This concentration of polymeric material which forms the film is primarily provided in the interior area of the press fabric and, primarily affects the compression characteristics and the rebound characteristics of the press fabric.

The same polymeric material may be contained in several layers of fibrous material. It is also feasible to utilize different polymeric materials in a plurality of layers of fibrous material, depending upon the desired elasticity characteristics.

At least one of the layers of fibrous material, possibly all layers are in the embodiment of a non-woven layer. The carrying structure may be a woven structure or a randomly laid structure.

The polymeric material which forms the film can further influence the permeability of the layer of fibrous material containing said polymeric material. At least one of the layers of fibrous material whose fibers are coated with the film may have a permeability of 30 cfm maximum, a 10 cfm maximum, or a 7 cfm maximum.

In addition, a method for the manufacture of a press fabric for the production of web material, is provided, including the following measures:
a) Provision of a carrying structure;
b) Provision of at least one layer of fibrous material;
c) Adding of particle shaped polymeric material into at least one layer of fibrous material;
d) Bonding the at least one layer of fibrous material with the carrying structure on one side of same, facing the web material contact surface; and
e) Causing the polymeric material to coat fibers in the layers of fibrous material at least partially in the form of a polymeric film.

A further development of the method of the present invention provides for a plurality of layers of fibrous material under the step b) into which the polymeric material that forms the film is subsequently furnished.

It is also feasible to provide layers of fibrous material into which either no polymeric material at all is added, or into which at least no polymeric material which forms a film is added. Structures are, therefore, feasible in which a polymeric material that forms a polymeric film is contained in at least one layer of fibrous material, as well as, at least one layer of fibrous material which does not contain polymeric material.

The step c) may provide for a particle-shaped polymeric material added into the layer of fibrous material as an aqueous dispersion of particle shaped, especially fine-particle shaped, polymeric material. Aqueous dispersions of this type are known, for example, under the name of “witcobond polymer dispersion”, and are marketed, for example, by Baxenden Chemicals Ltd. in England. In order to provide the film of polymeric material, polymer dispersions based on, for example, polyurethane or polyacrylate, or compounds of a plurality of polymer dispersions, for example, Impranil DLH or Witcobond 372-95, or any similar material with characteristics in comparable ranges, may be utilized.

Under the step e) the liquid may be removed from the aqueous dispersion, thereby creating the polymeric film. Under the step d) the individual layers of the fibrous material can be bonded with the carrying structure through needling. Needling has the advantage that, when inserting needles into the fibrous material, particles are carried over into adjacent layers through needle channels formed so that a bond is also formed between the individual layers through the particles.

One embodiment of the method of the present invention provides that the step c) is implemented prior to the step d). Here, it is feasible that the step c) is implemented prior to the step d) and the step d) is implemented prior to the step e). In this instance, therefore, the polymeric material is first added into the at least one fibrous layer. This layer is subsequently bonded with the carrying structure before the polymeric material is caused to form a film coating the fibers of the fibrous layer. In this scenario it is feasible that, when bonding the fibrous layer with the carrying structure, the polymeric material which still remains in the dispersion is transported into the carrying structure and adjacent fibrous layers, thereby improving the bonding between the layer and the carrying structure through the subsequent film formation. If the polymeric material is added into several layers of fibrous material, the polymeric material may be added into each of the layers of fibrous material separately, as long as they are not yet bonded with each other and with the carrying structure. In this scenario the volume and type of furnished polymeric material can be adjusted, targeted and independent of each other.

Alternatively, it is feasible that the step c) is implemented prior to the step e) and the step e) is implemented prior to the step d). In this scenario, the polymeric material that is added into the layer of fibrous material is caused to form a film before the layer of fibrous material is bonded with the carrying structure. In this connection, it is feasible to add the polymeric material separately into several layers of fibrous material respectively, and to cause the film formation before these layers are stacked onto each other and placed on the carrying structure and subsequently bonded with each other and with the carrying structure. If the polymeric material is added into several layers of fibrous material, then the polymeric material can be added into each layer of fibrous material separately, as long as these are not yet bonded with each other and with the carrying structure. In this scenario, the volume and type of furnished polymeric material can be adjusted and targeted independent of each other.

In another embodiment of the method of the present invention, it is feasible that the step d) is implemented prior to the step c) and the step c) is implemented prior to the step e). In this scenario, the at least one layer of fibrous material is first bonded with the carrying structure before the film forming polymeric material is added into the at least one fibrous layer and the film formation is caused.

At least 50% of the particles of the particle shaped polymeric material have a size in the range of 2.0 nm to 10 μm. Preferably, all particles of the particle shaped polymeric material have a size of 10 μm maximum, especially of 2 μm maximum. Particle size is to be understood to be the maximum dimension of the particle in one direction, in other words, in length, or width, or height. In addition, it is feasible that the polymeric material is added only into a section of the width of the at least one layer of fibrous material.

Another embodiment of the present invention provides that at least one of the layers of fibrous material which contains the polymeric material is formed by layer segments of partial widths relative to the width of the layer and which overlap each other or which are arranged side by side, adjoining each other.

In order to compress and/or smooth the structure formed from the polymeric material and the layer of fibrous material, the method of the present invention may include hot-calendering, whereby the hot-calendering occurs always after the step d).

A further advancement of the method of the present invention provides that an additional polymeric material is added into at least one of the layers of fibrous material, for example, into the layer providing the web material contact surface and/or the layer providing the machine contact surface and which, together with the fibers of this layer, forms a permeable composite structure in that the polymeric material fills the hollow spaces that are formed between the fibers of this layer only partially. The additional polymeric material is added into the fibrous layer, which may be particle shaped, in the form of an aqueous dispersion of particles and is subsequently melted and then cured in order to create the permeable composite structure.

The additional polymeric material may form a single component permeable polymeric layer. A single component polymeric layer is to be understood to be a polymeric layer which is formed from one single continuous component. In order to provide permeability, openings extend through the polymeric layer, whereby the openings in the polymeric layer are formed in that the polymeric material, which forms the polymeric layer, fills and/or bridges the hollow spaces between the fibers of the fibrous layer only partially. To verify that the permeable polymeric layer is a single component, the fibrous material—if it is, for example, polyamide—can be dissolved, for example, with formic acid.

The particle size of the additional polymeric material may be larger than the particles of the film forming polymeric material.

### BRIEF DESCRIPTION OF THE DRAWINGS

The above-mentioned and other features and advantages of the present invention, and the manner of attaining them, will become more apparent and the invention will be better understood by reference to the following description of embodiments of the invention taken in conjunction with the accompanying drawing, wherein:

FIG. 1 illustrates a schematic sectional of an inventively composed press fabric in an intermediate production phase;

Corresponding reference characters indicate corresponding parts throughout the several views. The exemplifications set out herein illustrate embodiments of the invention, in one form, and such exemplifications are not to be construed as limiting the scope of the invention in any manner.

### DETAILED DESCRIPTION OF THE INVENTION

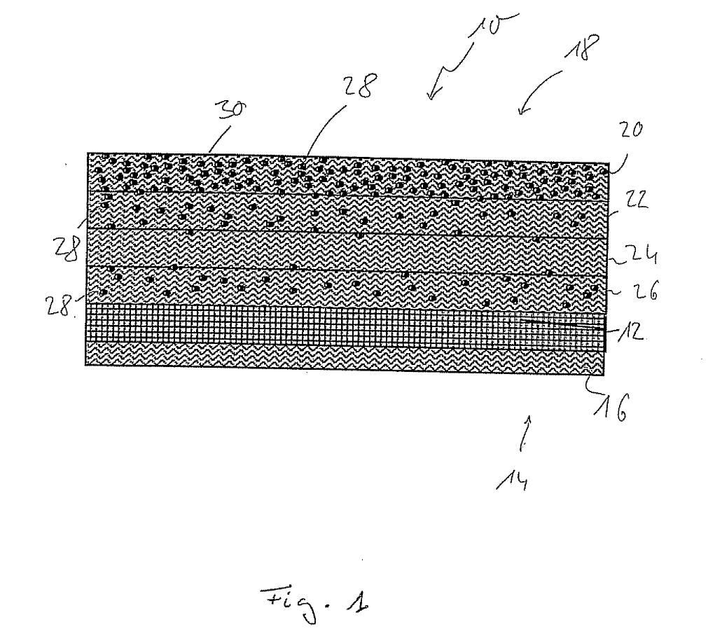

Referring now to the drawing, and more particularly to FIG. 1, there is illustrated a sectional view of press fabric 10 for the production of web material, which is utilized, for example, in a press section of a paper machine in order to convey the paper which is being manufactured through press nips. Press fabric 10 includes a carrying structure as a load absorbing layer, which may be in the form of a woven structure, a randomly laid structure or a so-called spiral-link-structure. On a side of carrying structure 12 that is facing toward machine contact side 14, layer 16 of fibrous material may, for example, be bonded by means of needling with carrying structure 12. Also, on one side of carrying structure 12, facing web material contact surface 18, a plurality of layers 20, 22, 24, and 26 of fibrous material are provided. In the illustrated intermediate production phase each of layers 20, 22, 24, and 26 of fibrous material contains fine particles 28 of polymeric material, for example, polyurethane material in the form of an aqueous dispersion. It can be seen that the density of particles 28 is not identical in individual layers 20, 22, 24, and 26. In the illustrated example, a comparatively high density of particles 28 is represented in layer 20 of fibrous material which, in the completed condition, provides web material contact surface 30, while layers 22 and 26 display a clearly lower, however, relative to each other, an essentially identical density. Layer 24 of fibrous material contains essentially no particles. The particles contained in layer 24 are at the boundary areas of adjacent layers of fibrous material 22 and 26, and migrated from these layers into layer 24.

In the manufacture of press fabric 10, individual layers 20, 22, 24, and 26 of fibrous material or base material which, for example, can be in the embodiment of non-woven or felt, is interspersed with particles 28. For example, this may be accomplished by applying, for example, an aqueous dispersion containing particles 28 onto this material. Particle 28 content in individual layers 20, 22, 24, and 26 of fibrous material can be achieved through the content of particles 28 in the dispersion, by the number of repeats of the application of said dispersion, and in consideration of the porous structure of the individual layers.

After the individual layers or the base material for these have been prepared with particles 28, the carrying liquid of the dispersion, for example, water is removed, for example, through the influence of temperature. This causes a polymeric film to form on the fibers in each of the layers which coats the fibers in these layers at least partially and bonds them with each other on the crossing points.

Subsequently, the layers are stacked over carrying structure 12, for example, by winding them in a spiral- or screw-like manner around carrying structure 12 which is carried over 2 rolls. Layers 20, 22, 24, and 26 of fibrous material are then bonded with carrying structure 12, whereby this bonding may occur through needling.

It is also feasible to first stack layers 20, 22, 24, and 26 on top of each other and to bond them with the carrying structure before the film formation is effected.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A press fabric for the production of a fibrous material web, said press fabric comprising:
a carrying structure;
at least one layer of fibrous material including a plurality of fibers, said at least one layer being configured to be firmly bonded with said carrying structure, and a polymeric material configured to form a film at least partially coating said fibers.

2. The press fabric according to claim 1, wherein said at least one layer of fibrous material includes a plurality of layers of fibrous material having a plurality of fibers, said fibers of said plurality of layers of fibrous material being coated by a film of said polymeric material.

3. The press fabric according to claim 2, wherein said plurality of layers of fibrous material include at least two layers of fibrous material being a first layer and a second layer, said first layer and said second layer having a different content of said polymeric material.

4. The press fabric according to claim 3, wherein said at least one layer of fibrous material has a web material contact surface being in closer proximity to said first layer than said second layer, said first layer having a first content of polymeric material and said second layer having a second content of polymeric material, said first content being higher than said second content.

5. The press fabric according to claim 3, wherein said at least one layer of fibrous material has a web material contact surface being in closer proximity to said first layer than said second layer, said first layer having a first content of polymeric material and said second layer having a second content of polymeric material, said first content being lower than said second content.

6. The press fabric according to claim 5, wherein said polymeric material is the same in several layers of said plurality of layers.

7. The press fabric according to claim 5, wherein said polymeric material is different in several layers of said plurality of layers.

8. The press fabric according to claim 2, wherein said at least one layer of said plurality of layers is a nonwoven layer.

9. The press fabric according to claim 1, wherein said carrying structure is one of a woven structure and a randomly laid structure.

10. The press fabric according to claim 9, wherein at least one layer of said plurality of layers has a permeability of less than 30 cfm.

11. The press fabric according to claim 10, wherein at least one layer of said plurality of layers has a permeability of less than 10 cfm.

12. The press fabric according to claim 11, wherein at least one layer of said plurality of layers a permeability of less than 7 cfm.

13. A method for manufacturing a press fabric for the production of web material, the method comprising:
(a) providing a carrying structure having a web material contact side;
(b) providing at least one layer of fibrous material having a plurality of fibers;
(c) providing particle shaped polymeric material, said particle shaped polymeric material being added into said at least one layer of fibrous material;
(d) bonding said at least one layer of fibrous material with said carrying structure on said web material contact side; and
(e) causing said polymeric material to at least partially coat said plurality of fibers of said at least one layer of fibrous material to form of a polymeric film.

14. The method for manufacturing a press fabric according to claim 13, further comprising said step of providing a plurality of fibrous layers of fibrous material.

15. The method for manufacturing a press fabric according to claim 14, wherein said particle shaped polymeric material in said step (c) is an aqueous dispersion of particle-shaped polymeric material.

16. The method for manufacturing a press fabric according to claim 15, wherein said particle shaped polymeric material is a fine-particle shaped polymeric material.

17. The method for manufacturing a press fabric according to claim 16, wherein said step (e) further comprises the step of removing liquid from said aqueous dispersion creating said polymeric film.

18. The method for manufacturing a press fabric according to claim 17, wherein said step (d) further comprises the step of bonding said at least one layer with said carrying structure by needling.

19. The method for manufacturing a press fabric according to claim 18, wherein said step (c) is implemented prior to said step (d).

20. The method for manufacturing a press fabric according to claim 19, wherein said step (c) is implemented prior to said step (d) and said step (d) is implemented prior to said step (e).

21. The method for manufacturing a press fabric according to claim 19, wherein said step (c) is implemented prior to said step (e) and said step (e) is implemented prior to said step (d).

22. The method for manufacturing a press fabric according to claim 18, wherein said step (d) is implemented prior to said step (c) and said step (c) is implemented prior to said step (e).

23. The method for manufacturing a press fabric according to claim 22, wherein at least 50% of said particles of fine particulate polymeric material have a size in the range of approximately 2.0 nm to 10 μm.

24. The method for manufacturing a press fabric according to claim 23, wherein all of said particles of fine particulate polymeric material have a maximum size of 10 μm.

25. The method for manufacturing a press fabric according to claim 24, wherein all of said particles of fine particulate polymeric material have a maximum size of 2 μm.

26. The method for manufacturing a press fabric according to claim 25, wherein said polymeric material is added only into a section of a width of said at least one layer of fibrous material.

27. The method for manufacturing a press fabric according to claim 26, wherein at least one layer of said plurality of layers is formed by a plurality of layer segments being a plurality of partial widths relative to said width of said at least one layer of said plurality of layers, said layer segments being configured to one of overlap each other and be arranged side by side adjoining each other.

28. The method for manufacturing a press fabric according to claim 27, further comprising the step of hot calendaring, said hot calendaring step always occurring after said step (d).

29. The method for manufacturing a press fabric according to claim 28, further comprising the step of providing another polymeric material in said at least one layer of fibrous material, said polymeric material only partially filling a plurality of hollow spaces between fibers of said at least one layer.

30. The method for manufacturing a press fabric according to claim 29, wherein said additional at least one layer of fibrous material is at least one of a layer having a web material contact surface and a layer having a machine contact surface, said polymeric material only partially filling a plurality of hollow spaces between fibers of said at least one layer.
